(19) United States
(12) Patent Application Publication
(10) Pub. No.: US 2005/0134532 A1
(43) Pub. Date: Jun. 23, 2005

(54) Apparatus and method for driving a plasma display panel

(76) Inventors: Joon-Young Choi, Saha-gu (KR); Chung Hoo Park, Yeonje-gu (KR); Dong-Hyun Kim, Seo-gu (KR); Ho Jun Lee, Geumjeong-gu (KR); Jae Young Lee, Nam-gu (KR); Joong Kyun Kim, Seoul (KR); Sang Kook Lee, Gumi-si (KR)

Correspondence Address: MCKENNA LONG & ALDRIDGE LLP, 1900 K STREET, NW, WASHINGTON, DC, 20006, US

(21) Appl. No.: 10/980,823

(22) Filed: Nov. 4, 2004

(30) Foreign Application Priority Data
Nov. 4, 2003 (KR) 10-2003-0077655

(51) Int. Cl. G09G 3/28

(52) U.S. Cl. 345/60

(57) ABSTRACT

The present invention relates to a plasma display panel, and more particularly, to an apparatus and method for driving a plasma display panel. According to an embodiment of the present invention, the apparatus for driving the plasma display panel includes a temperature sensor that senses a temperature of the plasma display panel, an erase signal tilt control unit that controls a tilt of an erase signal for erasing charges within a cell of the plasma display panel depending on the sensed temperature, and a driving unit that supplies an initialization signal for initializing the cell, an address signal for selecting the cell and a sustain signal for generating a sustain discharge in the cell to the plasma display panel after the charges within the cell are erased using the erase signal. Accordingly, a stabilized discharge can be implemented in such a manner that an ambient temperature is sensed when the plasma display panel is driven, an erase signal is controlled according to the sensed ambient temperature, and the controlled erase signal is applied.

This Nonprovisional application claims priority under 35 U.S.C. § 119(a) on Patent Application No. 10-2003-0077655 filed in Korea on Nov. 4, 2003, the entire contents of which are hereby incorporated by reference.

### BACKGROUND OF THE INVENTION

1. Field of the Invention

The present invention relates to a plasma display panel, and more particularly, to an apparatus and method for driving a plasma display panel.

2. Description of the Background Art

A plasma display panel (hereinafter, referred to as a ‘PDP’) is adapted to display an image by light-emitting phosphors with ultraviolet generated during the discharge of an inert mixed gas such as He+Xe, Ne+Xe or He+Ne+Xe. This PDP can be easily made thin and large, and it can provide greatly increased image quality with the recent development of the relevant technology.

FIG. 1 is a plan view schematically showing arrangement of electrodes of a conventional 3-electrode AC surface discharge type PDP.

Referring to FIG. 1, the discharge cell of the conventional 3-electrode AC surface discharge type PDP includes scan electrodes Y1 to Yn, a sustain electrode Z, and address electrodes X1 to Xm that intersect the scan electrodes Y1 to Yn and the sustain electrode Z.

Cells 1 for displaying a visible ray of one of red, green and blue lights are formed at the intersections of the scan electrodes Y1 to Yn, the sustain electrode Z and the address electrodes X1 to Xm. The scan electrodes Y1 to Yn and the sustain electrode Z are formed on an upper substrate (not shown. On an upper substrate is laminated a dielectric layer (not shown and a MgO protection layer (not shown. The address electrodes X1 to Xm are formed on a lower substrate (not shown. On the lower substrate are formed barrier ribs for preventing optical and electrical interference among the cells which are adjacent to one another horizontally. Phosphors that are excited by a vacuum ultraviolet ray to emit a visible ray are formed on the surface of the lower substrate and the barrier ribs. An inert mixed gas such as He+Xe, Ne+Xe or He+Xe+Ne is injected into discharge spaces defined between the upper substrate and the lower substrate. A method of processing the gray scale of an image of the conventional PDP constructed above is shown in FIG. 2.

Referring to FIG. 2, the PDP is time-driven with one frame being divided into several sub-fields having a different number of emission in order to implement the gray scale of an image. Each of the sub-fields is divided into a reset period for initializing the entire screen, an address period for selecting a scan line and selecting a cell from the selected scan line, and a sustain period for implementing the gray scale depending on the number of a discharge. For example, if it is desired to display an image with 256 gray scale, a frame period (16.67 ms) corresponding to 1/60 seconds is divided into eight sub-fields SF1 to SF8, as shown in FIG. 2. Furthermore, each of the eight sub-fields SF1 to SF8 is subdivided into a reset period, an address period and a sustain period. In this time, the reset period and the address period of each of the sub-fields are the same every sub-field, whereas the sustain period and the number of a sustain pulse allocated thereto are increased in the ratio of 2ⁿ (n=0,1,2,3,4,5,6,7 in each sub-field.

FIG. 3 shows a driving waveform of the PDP that is supplied to one sub-field.

Referring to FIG. 3, the PDP is driven with it being divided into a reset period for initializing the entire screen, an address period for selecting a cell, and a sustain period for maintaining discharging of a selected cell.

At the initial stage of the reset period, a ramp-up waveform Ramp-up is supplied to all the scan electrodes Y simultaneously. At the same time, a voltage of 0[V] is applied to the sustain electrode Z and the address electrodes X. The ramp-up waveform Ramp-up causes a writing dark discharge in which light is rarely generated to occur between the scan electrodes Y and the address electrodes X and between the scan electrodes Y and the sustain electrode Z within the cells of the whole screen. Wall charges of the positive (+) polarity are accumulated on the address electrodes X and the sustain electrode Z and wall charges of the negative (−) polarity are accumulated on the scan electrodes Y, by means of the writing dark discharge.

After the ramp-up waveform Ramp-up, a ramp-down waveform Ramp-dn in which a voltage starts to fall from a voltage of the positive polarity lower than the peak voltage of the ramp-up waveform Ramp-up to a ground voltage GND or a given voltage level of the negative polarity is supplied to the scan electrodes Y simultaneously. At the same time, a sustain voltage (Vs) is applied to the sustain electrode Z and a voltage of 0[V] is supplied to the address electrodes X. When the ramp-down waveform Ramp-dn is applied, an erasing dark discharge occurs between the scan electrodes Y and the sustain electrode Z. Excessive wall charges that are unnecessary for an address discharge among the wall charges that are generated upon the writing dark discharge are erased by the erasing dark discharge. Variation in distribution of the wall charges in the reset period is as follows. There is almost no variation in the wall charges on the address electrodes X, but some of the wall charges of the negative (−) polarity which are formed by the writing dark discharge on the scan electrodes Y are erased by the erasing dark discharge.

In the address period, a scan pulse Sp is sequentially supplied to the scan electrodes Y, and at the same time a data pulse Dp synchronized with the scan pulse Sp is provided to the address electrodes X. As a voltage difference between the scan pulse Sp and the data pulse Dp and the wall voltage generated in the reset period are added, an address discharge is generated within cells to which the data pulse Dp is supplied.

In the sustain period, a sustain pulse sus is alternately applied to the scan electrodes Y and the sustain electrode Z. As the wall voltage within the cells and the sustain pulse sus are added, a sustain discharge, i.e., a display discharge is generated between the scan electrodes Y and the sustain electrode Z in the cell selected by the address discharge whenever the sustain pulse sus is supplied.

After the sustain discharge is completed, an erase ramp waveform ramp-ers in which a voltage gradually rises up to a sustain voltage Vs is supplied to the sustain electrode Z, thus erasing the wall charges remaining in the cells of the whole screen.

In this PDP, however, if the PDP is driven in full white or the gray scale close to full while at high or low temperature, there are problems in that a turning-off phenomenon of a cell (hereinafter, referred to as ‘high-temperature erroneous discharge’) is generated due to a jittering phenomenon in which a discharge time of an address period is extended, a scratch phenomenon (hereinafter, referred to as ‘low-temperature erroneous discharge’) in which a non-selected cell is turned on to generate a hot spot or an erroneous discharge is continuously generated in a vertical line, etc. This is because the amount of wall charges accumulated on the address electrodes X and the scan electrodes Y in the reset period varies depending on an ambient temperature. This erroneous discharge depending on variation in temperature is influenced by weather and geography and thus becomes a major factor to lower competitive power of a PDP.

### SUMMARY OF THE INVENTION

Accordingly, an object of the present invention is to solve at least the problems and disadvantages of the background art.

An object of the present invention is to provide an apparatus and method for driving a plasma display panel in which a stabilized discharge is generated regardless of variation in a temperature when the plasma display panel is driven.

According to a first embodiment of the present invention, there is provided an apparatus for driving a plasma display panel, including a temperature sensor that senses a temperature of the plasma display panel, an erase signal tilt control unit that controls a tilt of an erase signal for erasing charges within a cell of the plasma display panel depending on the sensed temperature, and a driving unit that supplies an initialization signal for initializing the cell, an address signal for selecting the cell and a sustain signal for generating a sustain discharge in the cell to the plasma display panel after the charges within the cell are erased using the erase signal.

According to a first embodiment of the present invention, there is provided a method of driving a plasma display panel, including the steps of sensing a temperature of the plasma display panel, controlling a tilt of an erase signal for erasing charges within a cell of the plasma display panel depending on the sensed temperature, and erasing the charges within the cell using the erase signal and then supplying an initialization signal for initializing the cell, an address signal for selecting the cell and a sustain signal for generating a sustain discharge in the cell to the plasma display panel.

According to a second embodiment of the present invention, there is provided an apparatus for driving a plasma display panel, including a temperature sensor that senses a temperature of the plasma display panel, an erase signal voltage control unit that controls a voltage of an erase signal for erasing charges within a cell of the plasma display panel depending on the sensed temperature, and a driving unit that supplies an initialization signal for initializing the cell, an address signal for selecting the cell and a sustain signal for generating a sustain discharge in the cell to the plasma display panel after the charges within the cell are erased using the erase signal.

According to a second embodiment of the present invention, there is provided a method of driving a plasma display panel, including the steps of sensing a temperature of the plasma display panel, controlling a voltage of an erase signal for erasing charges within a cell of the plasma display panel depending on the sensed temperature, and supplying an initialization signal for initializing the cell, an address signal for selecting the cell and a sustain signal for generating a sustain discharge in the cell to the plasma display panel after the charges within the cell are erased using the erase signal.

According to the apparatus and method for driving the plasma display panel in accordance with the first and second embodiments of the present invention, a stabilized discharge can be implemented in such a manner that an ambient temperature is sensed when the plasma display panel is driven, an erase signal is controlled according to the sensed ambient temperature, and the controlled erase signal is applied.

### BRIEF DESCRIPTION OF THE DRAWINGS

The invention will be described in detail with reference to the following drawings in which like numerals refer to like elements.

FIG. 1 is a plan view schematically showing arrangement of electrodes of a conventional 3-electrode AC surface discharge type PDP.

FIG. 2 is a view shown to explain a method of processing the gray scale of an image of the conventional PDP.

FIG. 3 shows a driving waveform of the PDP that is supplied to one sub-field.

FIG. 4 shows the configuration of an apparatus for driving a PDP according to a first embodiment of the present invention.

FIG. 5 shows a driving waveform for explaining a method of driving a PDP according to a first embodiment of the present invention.

FIG. 6 shows a discharge optical waveform illustrating a time point where a writing dark discharge is generated when an erase signal having a constant tilt is applied, and the intensity of discharge thereof.

FIG. 7 shows the relationship between a tilt of an erase signal and a discharge optical waveform shown upon the address discharge.

FIG. 8 shows variation in a wavelength spectrum of light when an ambient temperature of a PDP rises under the condition in which a tilt of an erase signal is set to 6V/μs.

FIG. 9 shows variation in color temperature when an ambient temperature of a PDP rises under the condition in which a tilt of an erase signal is set to 6V/μs.

FIG. 10 shows the relationship between increased temperature and a discharge optical waveform depending on a writing dark discharge of a reset period under the condition in which a tilt of an erase signal is set to 6V/μs.

FIG. 11 shows a discharge optical waveform illustrating variation in an address discharge when a tilt of an erase signal varies.

FIG. 12 shows the configuration of an apparatus for driving a PDP according to a second embodiment of the present invention.

FIG. 13 shows a driving waveform for explaining a method of driving a PDP according to a second embodiment of the present invention.

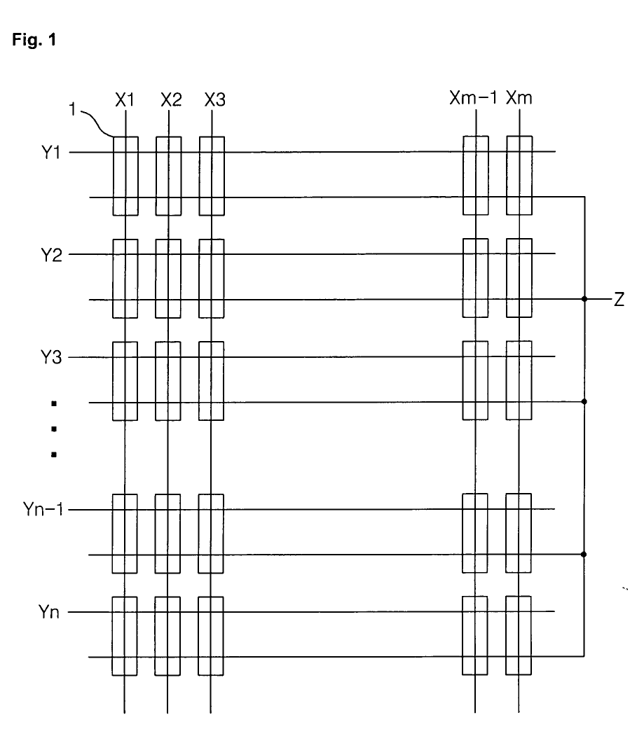

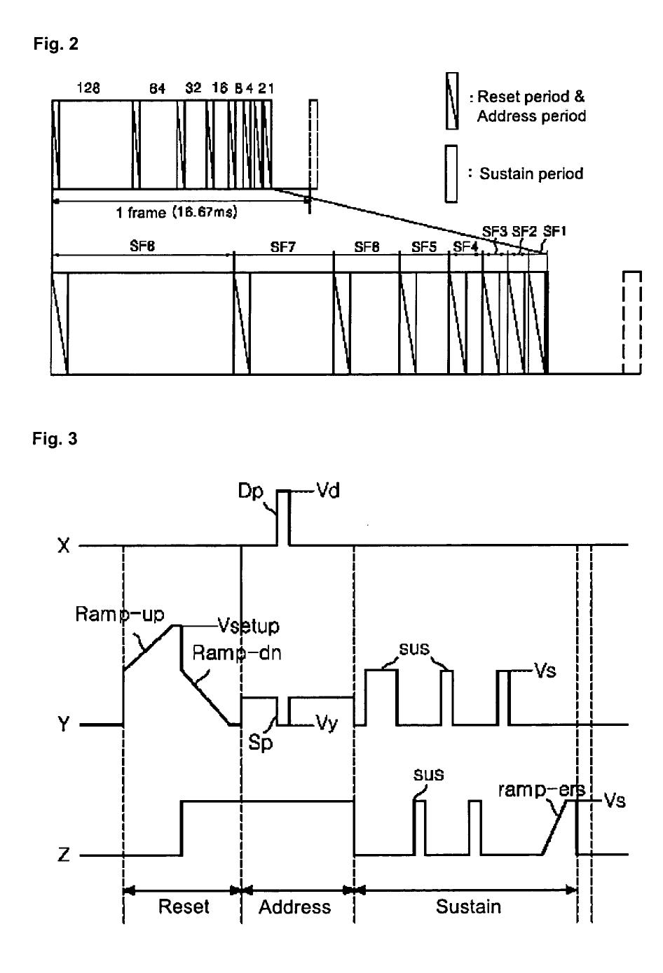

### DETAILED DESCRIPTION OF PREFERRED EMBODIMENTS

Preferred embodiments of the present invention will be described in a more detailed manner with reference to the drawings.

### First Embodiment

According to a first embodiment of the present invention, there is provided an apparatus for driving a plasma display panel, including a temperature sensor that senses a temperature of the plasma display panel, an erase signal tilt control unit that controls a tilt of an erase signal for erasing charges within a cell of the plasma display panel depending on the sensed temperature, and a driving unit that supplies an initialization signal for initializing the cell, an address signal for selecting the cell and a sustain signal for generating a sustain discharge in the cell to the plasma display panel after the charges within the cell are erased using the erase signal.

The erase signal tilt control unit controls the tilt of the erase signal to vary within a range between 0.1V/μs and 1800V/μs.

The erase signal tilt control unit controls the tilt of the erase signal to vary within a range between 2V/μs and 20V/μs.

The erase signal tilt control unit controls the tilt of the erase signal to be higher than a reference tilt at room temperature if the temperature of the plasma display panel rises from room temperature to a high temperature.

The erase signal tilt control unit controls the tilt of the erase signal to be lower than a reference tilt at room temperature if the temperature of the plasma display panel falls from room temperature to a low temperature.

According to a first embodiment of the present invention, there is provided a method of driving a plasma display panel, including the steps of sensing a temperature of the plasma display panel, controlling a tilt of an erase signal for erasing charges within a cell of the plasma display panel depending on the sensed temperature, and erasing the charges within the cell using the erase signal and then supplying an initialization signal for initializing the cell, an address signal for selecting the cell and a sustain signal for generating a sustain discharge in the cell to the plasma display panel.

The tilt of the erase signal varies within a range between 0.1V/μs and 1800V/μs.

The tilt of the erase signal varies within a range between 2V/μs and 20V/μs.

The step of controlling the tilt of the erase signal includes controlling the tilt of the erase signal to be higher than a reference tilt at room temperature if the temperature of the plasma display panel rises from room temperature to a high temperature.

The step of controlling the tilt of the erase signal includes controlling the tilt of the erase signal to be lower than a reference tilt at room temperature if the temperature of the plasma display panel falls from room temperature to a low temperature.

The room temperature ranges from 0□ and 50□ and the high temperature ranges from 50□ to 100□.

An apparatus and method for driving a PDP according to a first embodiment of the present invention will now be described in detail with reference to the accompanying drawings.

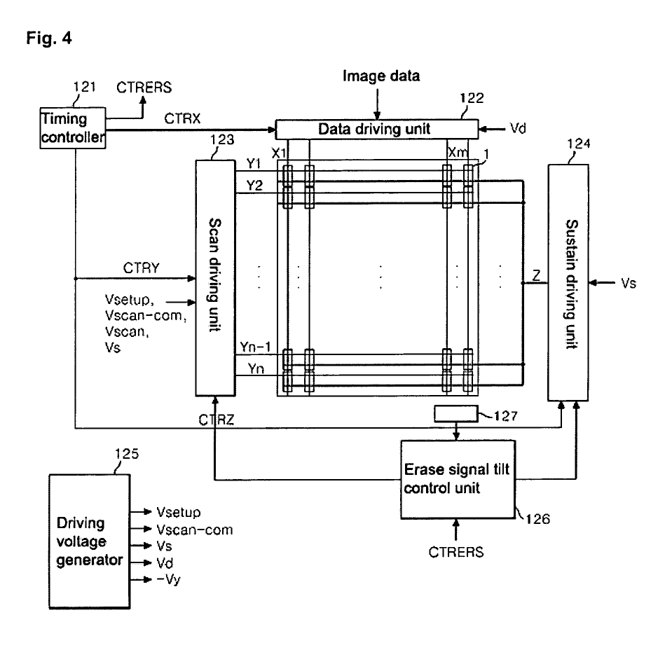

FIG. 4 shows the configuration of an apparatus for driving a PDP according to a first embodiment of the present invention.

Referring to FIG. 4, the apparatus for driving the PDP according to the first embodiment of the present invention includes a data driving unit 122 for supplying data to address electrodes X1 to Xm of the PDP, a scan driving unit 123 for driving scan electrodes Y1 to Yn, a sustain driving unit 124 for driving a sustain electrode Z being a common electrode, a temperature sensor 127 for sensing a temperature of the PDP, an erase signal tilt control unit 126 for controlling a tilt of an erase signal VRamp-ers being a ramp waveform depending on the temperature of the PDP, a timing controller 121 for controlling the data driving unit 122, the scan driving unit 123, the sustain driving unit 124 and the erase signal tilt control unit 126, and a driving voltage generator 125 for supplying a driving voltage needed for each of the driving units 122, 123 and 124.

To the data driving unit 122 is supplied data which undergoes inverse-gamma correction and error diffusion processes by an reverse gamma correction circuit and an error diffusion circuit (not shown) and is then mapped to each sub-field by a sub-field mapping circuit. The data driving unit 122 samples and latches the data in response to a timing control signal CTRX from the timing controller 121 and supplies the data to the address electrodes X1 to Xm.

The scan driving unit 123 supplies a ramp-up waveform Ramp-up and a ramp-down waveform Ramp-down to the scan electrodes Y1 to Yn during a reset period under the control of the timing controller 121. Further, the scan driving unit 123 sequentially supplies a scan pulse Sp of a scan voltage (−Vy) to the scan electrodes Y1 to Yn during an address period and supplies a sustain pulse sus to the scan electrodes Y1 to Yn during a sustain period, under the control of the timing controller 121. Also, the scan driving unit 123 applies an erase signal VRamp-ers being a ramp waveform whose tilt is controlled by the erase signal tilt control unit 126 to the scan electrodes Y1 to Yn in the case where after a discharge is generated as the last sustain pulse sus is supplied to the sustain electrode Z in at least one sub-field.

The sustain driving unit 124 supplies a bias voltage of a sustain voltage (Vs) to the sustain electrode Z during a period where the ramp-down waveform Ramp-down is generated and the address period and alternately operates with the scan driving unit 123 during the sustain period to apply the sustain pulse sus to the sustain electrode Z, under the control of the timing controller 121. Further, the sustain driving unit 124 provides the erase signal VRamp-ers being a ramp waveform whose tilt is controlled by the erase signal tilt control unit 126 to the sustain electrode Z in the case where after a discharge is generated as the last sustain pulse sus is provided to the scan electrodes Y1 to Yn in one or more sub-fields.

The temperature sensor 127 is disposed on a printed circuit board (PCB) that is folded to the rear side of the PDP or an additional device located close to the PDP, and it serves to sense an ambient temperature of the PDP and to supply an electrical signal indicating the sensed temperature to the erase signal tilt control unit 126. The driving units 122, 123 and 124 of the PDP are mounted on the PCB.

The erase signal tilt control unit 126 controls a tilt of the erase signal VRamp-ers being a ramp waveform in response to the temperature sensing signal from the temperature sensor 127 and a control signal CTRRES of the timing controller 121. That is, the erase signal tilt control unit 126 serves to increase the tilt of the erase signal VRamp-ers when a temperature of the PDP rises from room temperature to high temperature and lower the tilt of the erase signal VRamp-ers when a temperature of the PDP decreases from room temperature to low temperature. In this time, the room temperature ranges from 0□ to 50□, the high temperature ranges from 50□ to 100□ and the low temperature ranges from −20□ to 0□. Further, it is preferred that the erase signal tilt control unit 126 controls the tilt of the erase signal to be vary within a range between 0.1V/μs and 180V/μs considering a lifespan characteristic of the entire PDP including an voltage-resistant characteristic of a switch constituting the PDP, more preferably between 2V/μs and 20V/μs.

To this end, the erase signal tilt control unit 126 includes a switch element for selecting a plurality of resistors and a plurality of capacitors depending on a temperature in order to adjust a RC time constant. The erase signal tilt control unit 126 may include a thermometer whose resistance varies depending on a temperature, if needed, and can be thus integrated into the temperature sensor 127.

This erase signal tilt control unit 126 can be built in one of the scan driving unit 123 and the sustain driving unit 124.

The timing controller 121 receives a vertical/horizontal synchronization signal and a clock signal, and generates timing control signals CTRX, CTRY, CTRZ and CTRERS for controlling an operating timing and synchronization of each of the driving units 122, 123 and 124 and the erase signal tilt control unit 126. The timing controller 121 also applies the timing control signals CTRX, CTRY, CTRZ and CRRERS to corresponding driving units 122, 123 and 124 and the erase signal tilt control unit 126, thus controlling the driving units 122, 123 and 124 and the erase signal tilt control unit 126. The data control signal CTRX includes a sampling clock for sampling data, a latch control signal, and a switch control signal for controlling an on/off time of an energy recovery circuit and a driving switch element. The scan control signal CTRY includes a switch control signal for controlling an on/off time of an energy recovery circuit and a driving switch element within the scan driving unit 123. The sustain control signal CTRZ includes a switch control signal for controlling an on/off time of an energy recovery circuit and a driving switch element within the sustain driving unit 124. Further, the erase signal tilt control signal CTRRES includes a control signal of switch elements included in the erase signal tilt control unit 126.

The driving voltage generator 125 generates a set-up voltage Vsetup, a common scan voltage Vscan-com, a scan voltage (−Vy), a sustain voltage (Vs), a data voltage (Vd) and the like. These driving voltages may vary depending on the composition of a discharge gas or the construction of a discharge cell.

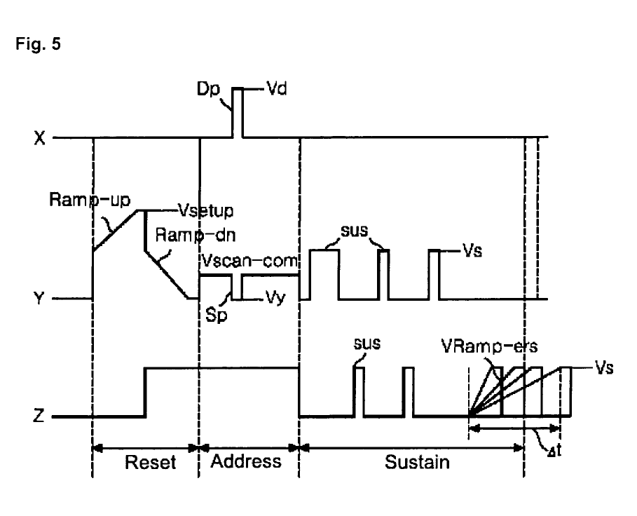

FIG. 5 shows a driving waveform for explaining a method of driving a PDP according to a first embodiment of the present invention.

Referring to FIG. 5, in the method of driving the PDP according to the first embodiment of the present invention, one frame period is time-divided into a plurality of sub-fields each of which has a reset period, an address period and a sustain period. A tilt of an erase signal applied after a sustain discharge in at least one sub-field varies depending on an ambient temperature. That is, a temperature of the PDP is sensed, the tilt of the erase signal for erasing charges within a cell of the PDP is controlled according to on the sensed temperature, and an initialization signal for initializing the cell after the charges within the cell are erased using the erase signal, an address signal for selecting the cell and a sustain signal for generating the sustain discharge in the cell are supplied to the PDP. This will be below described in detail.

Firstly, at the initial stage of the reset period, a ramp-up waveform Ramp-up is supplied to all the scan electrodes Y simultaneously. At the same time, a voltage of 0[V] is applied to the sustain electrode Z and the address electrodes X. The ramp-up waveform Ramp-up causes a writing dark discharge in which light is rarely generated to occur between the scan electrodes Y and the address electrodes X and between the scan electrodes Y and the sustain electrode Z within the cells of the whole screen. Wall charges of the positive (+) polarity are accumulated on the address electrodes X and the sustain electrode Z and wall charges of the negative (−) polarity are accumulated on the scan electrodes Y, by means of the writing dark discharge. This writing dark discharge varies depending on the tilt of the erase signal for erasing remaining charges within the cell immediately before the reset period.

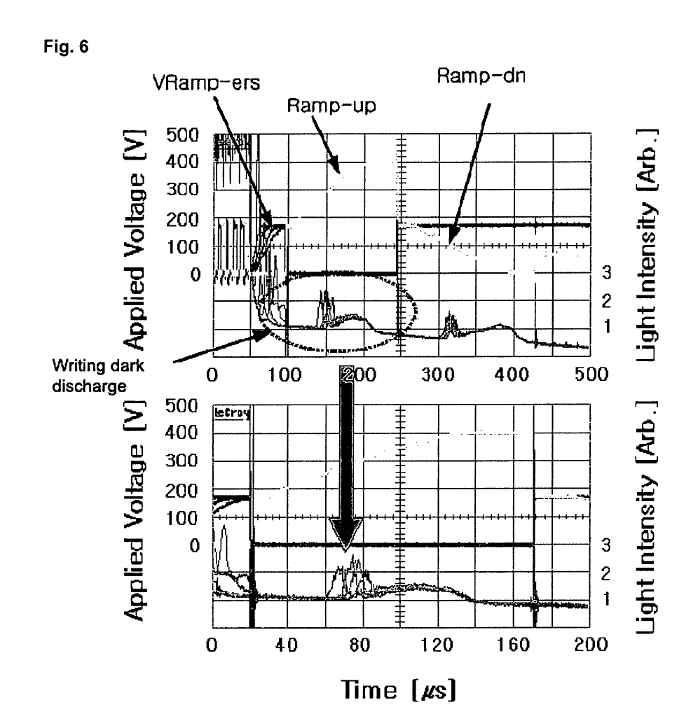

FIG. 6 shows a discharge optical waveform illustrating a time point where a writing dark discharge is generated when an erase signal having a constant tilt is applied after the last sustain discharge, and the intensity of discharge thereof.

That is, FIG. 6 shows the optical waveform of the writing dark discharge that is represented by supplying the erase signal having a constant tilt. In this time, in the optical waveform of the dark discharge, if the tilt of the erase signal VRamp-ers is great, a writing dark discharge is generated rapidly and strongly. As a result, a large amount of wall charges is accumulated on the address electrodes and the sustain electrode. On the contrary, if the tilt of the erase signal VRamp-ers is small, the writing dark discharge is generated slowly and weakly. Resultantly, a small amount of wall charges is accumulated on the address electrode and the sustain electrode.

After the ramp-up waveform Ramp-up of the reset period, a ramp-down waveform Ramp-dn in which a voltage starts to fall from a voltage of the positive polarity lower than the peak voltage of the ramp-up waveform Ramp-up to a ground voltage GND or a given voltage level of the negative polarity is supplied to the scan electrodes Y simultaneously. At the same time, a sustain voltage (Vs) is applied to the sustain electrode Z and a voltage of 0[V] is supplied to the address electrodes X. When the ramp-down waveform Ramp-dn is applied, an erasing dark discharge occurs between the scan electrodes Y and the sustain electrode Z. Excessive wall charges that are unnecessary for an address discharge among the wall charges that are generated upon the writing dark discharge are erased by the erasing dark discharge. Variation in distribution of the wall charges in the reset period is as follows. There is almost no variation in the wall charges on the address electrodes X, but some of the wall charges of the negative (−) polarity, which are formed on the scan electrodes Y by the writing dark discharge, are erased by the erasing dark discharge. On the contrary, in the case of the wall charges on the sustain electrode Z, although the wall charges of the positive polarity was accumulated in the writing dark discharge, the wall charges of the negative polarity are accumulated as much as the amount that the wall charges on the scan electrodes Y are reduced as the wall charges of the negative polarity that are accumulated on the scan electrodes Y at the time of the erasing dark discharge are moved to the sustain electrode Z. Thus, the polarity of the wall charges on the sustain electrode Z is changed from the positive polarity to the negative polarity immediately after the erasing dark discharge.

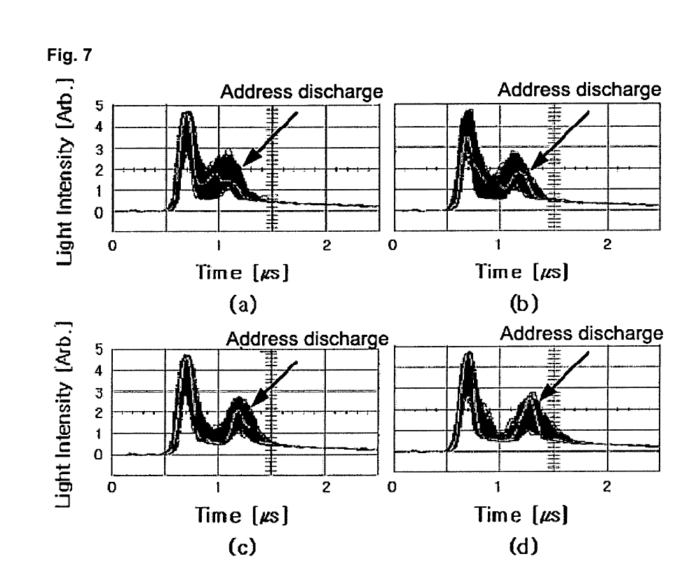

In the address period, a scan pulse Sp is sequentially supplied to the scan electrodes Y, and at the same time a data pulse Dp synchronized with the scan pulse Sp is provided to the address electrodes X. As a voltage difference between the scan pulse Sp and the data pulse Dp and the wall voltage generated in the reset period are added, an address discharge is generated within cells to which the data pulse Dp is supplied. Wall charges of the amount that can causes a discharge to occur when the sustain voltage (Vs) is applied are formed within a cell selected by the address discharge. During the address period, the sustain voltage (Vs) is applied to the sustain electrode Z. This address discharge varies depending on the amount of initial wall charges generated upon the writing dark discharge that varies when the tilt of the erase signal is changed as in FIG. 7.

FIG. 7 shows the relationship between a tilt of an erase signal and a discharge optical waveform shown upon the address discharge.

That is, FIG. 7(a) and FIG. 7(b) show address discharge optical waveforms represented when the tilts of the erase signal are 18V/μs and 9V/μs (b), respectively, and FIG. 7(c) and FIG. 7(d) show address discharge optical waveforms represented when the tilts of the erase signal are 6V/μs and 4.5V/μs (b), respectively.

From FIG. 7, it can be seen that the address discharge is generated approximately 1 μs when the tilts of the erase signal are 18V/μs and 9V/μs (b) and the address discharge is generated approximately 1.25 μs when the tilts of the erase signal Ramp-ers are 6V/μs and 4.5V/μs.

In the sustain period, a sustain pulse sus is alternately applied to the scan electrodes Y and the sustain electrode Z. As the wall voltage within the cells and the sustain pulse sus are added, a sustain discharge, i.e., a display discharge is generated between the scan electrodes Y and the sustain electrode Z in the cell selected by the address discharge whenever the sustain pulse sus is supplied.

After the sustain discharge is completed, an erase signal VRamp-ers being a ramp waveform whose voltage that varies depending on an ambient temperature of the PDP gradually rises up to the sustain voltage Vs is supplied to the sustain electrode Z, thus erasing the wall charges remaining in the cells of the whole screen. The tilt of the erase signal increases when a temperature of the PDP rises from room temperature to a high temperature and decreases when a temperature of the PDP falls from room temperature to a low temperature. The tilt is set to vary preferably within a range between 0.1V/μs and 180V/μs considering the lifespan characteristic of the entire PDP including a voltage-resistant characteristic of switches constituting the PDP, more preferably between 2V/μs and 20V/μs. In this time, the room temperature ranges from 0□ to 50□, the high temperature ranges from 50□ to 100□, and the low temperature ranges from −20□ to 0□.

This erase signal VRamp-ers serves to control the writing dark discharge of the reset period as described above, thus compensating for the amount of variations in the wall charges formed on the scan electrode and the address electrodes depending on a temperature.

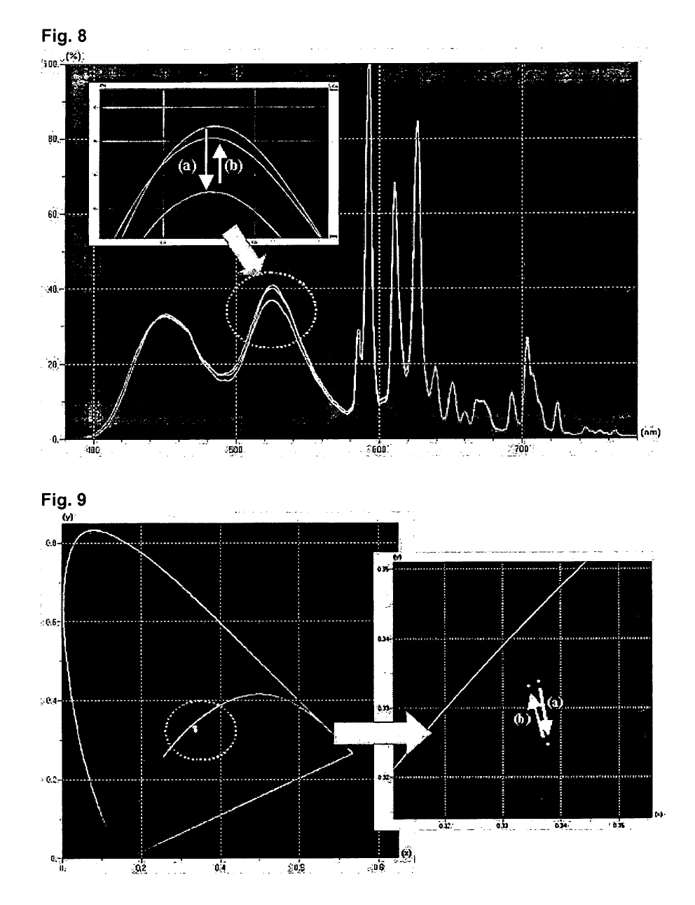

FIG. 8 to FIG. 10 illustrate experimental values for verifying the effects obtained by the method of driving the PDP according to the first embodiment of the present invention.

FIG. 8 shows variation in a wavelength spectrum of light when an ambient temperature of a PDP rises under the condition in which a tilt of an erase signal is set to 6V/μs. That is, FIG. 8(a) shows that the peak 5384 nm of the wavelength spectrum [nm] of light is changed to 5209 nm due to a high temperature erroneous discharge when an ambient temperature of the PDP rises from room temperature to a high temperature of 70□ or more under the condition in which the tilt of the erase signal VRamp-ers is set to 6V/μs. The change of the wavelength spectrum [nm] of light depending on a temperature is compensated for in such a manner that the peak 5209 nm of the wavelength spectrum [nm] of light is changed to 5306 nm by increasing the tilt of the erase signal VRamp-ers to 18V/μs as in FIG. 8(b).

FIG. 9 shows a color coordinate value illustrating variation in color temperature when an ambient temperature of a PDP rises under the condition in which the tilt of the erase signal is set to 6V/μs. That is, FIG. 9(a) shows that color temperature of green decreases as the amount of light of a green cell becomes weak when an ambient temperature of the PDP rises from room temperature to a high temperature of 70□ or more under the condition in which the tilt of the erase signal VRamp-ers is set to 6V/μs. Such change in color temperature is restored to an optimum color temperature by increasing the tilt of the erase signal VRamp-ers to 18V/μs, as in FIG. 9(b).

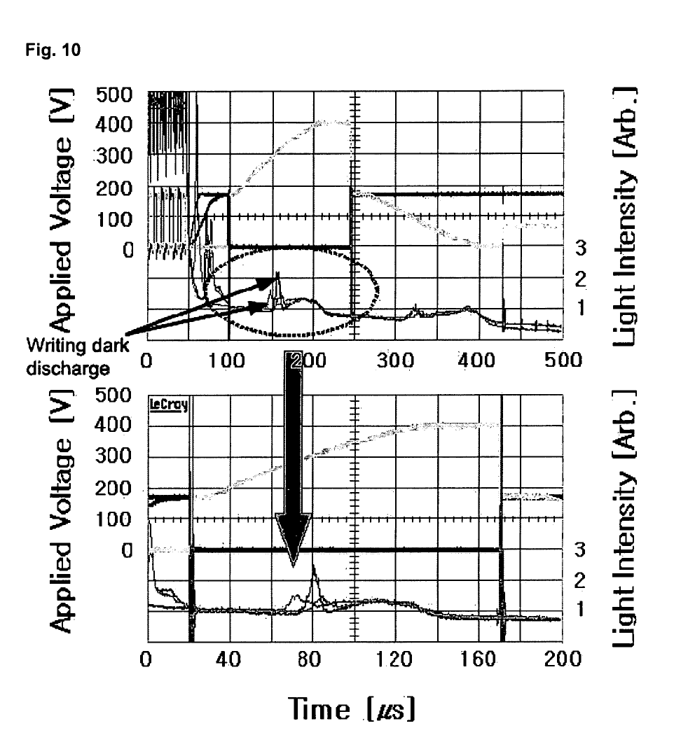

FIG. 10 shows the relationship between increased temperature and a discharge optical waveform depending on a writing dark discharge of a reset period under the condition in which a tilt of an erase signal is set to 6V/μs. That is, FIG. 10 shows that a writing dark discharge of a reset period is delayed as a discharge jitter value increases under the condition in which the tilt of the erase signal VRamp-ers at a high temperature of 70□ or more is set to 6V/μs. If the tilt of the erase ramp waveform VRamp-ers is increased to 18V/μs under this high temperature environment, the writing dark discharge (green) is generated rapidly.

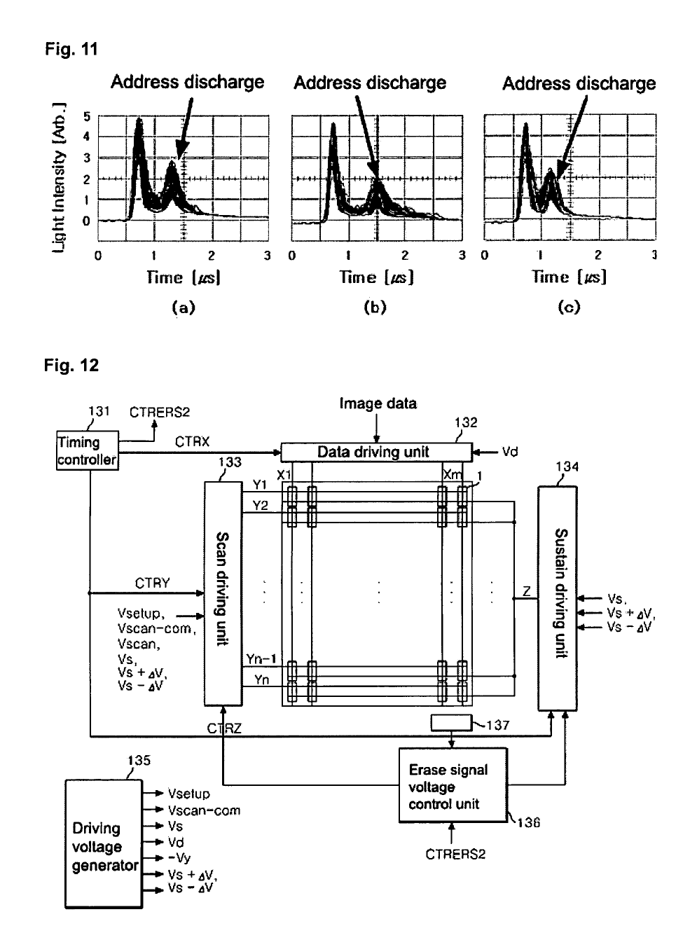

FIG. 11 shows a discharge optical waveform illustrating variation in an address discharge when the tilt of the erase signal varies. That is, FIG. 11(a) shows the address discharge that is generated under the condition in which the tilt of the erase signal VRamp-ers is set to 6V/μs and a temperature is room temperature. FIG. 11(b) shows that the address discharge is delayed due to increase of a discharge jitter value as an ambient temperature of a PDP rises to a high temperature of 70□ or more when the tilt of the erase ramp waveform VRamp-ers is 6V/μs.

If the tilt of the erase ramp waveform VRamp-ers is increased to 18V/μs in this high temperature environment, the address discharge of FIG. 11(c) is generated rapidly.

As such, in the method of driving the PDP according to the first embodiment of the present invention, the tilt of the erase signal VRamp-ers varies depending on a temperature. Thus, an address discharge can be stabilized in any environment by preventing a high temperature erroneous discharge or a low temperature erroneous discharge although the PDP is used at high temperature or low temperature.

### Second Embodiment

According to a second embodiment of the present invention, there is provided an apparatus for driving a plasma display panel, including a temperature sensor that senses a temperature of the plasma display panel, an erase signal voltage control unit that controls a voltage of an erase signal for erasing charges within a cell of the plasma display panel depending on the sensed temperature, and a driving unit that supplies an initialization signal for initializing the cell, an address signal for selecting the cell and a sustain signal for generating a sustain discharge in the cell to the plasma display panel after the charges within the cell are erased using the erase signal.

The erase signal voltage control unit raises the voltage of the erase signal up to a voltage within a range between 80V and 280V.

The erase signal voltage control unit raises the voltage of the erase signal up to a voltage between 155V and 205V.

The erase signal voltage control unit controls the voltage of the erase signal to be higher than a voltage of the sustain signal if the temperature of the plasma display panel rises from room temperature to a high temperature.

The erase signal voltage control unit controls the voltage of the erase signal to be lower than a voltage of the sustain signal if the temperature of the plasma display panel falls from room temperature to a low temperature.

According to a second embodiment of the present invention, there is provided a method of driving a plasma display panel, including the steps of sensing a temperature of the plasma display panel, controlling a voltage of an erase signal for erasing charges within a cell of the plasma display panel depending on the sensed temperature, and supplying an initialization signal for initializing the cell, an address signal for selecting the cell and a sustain signal for generating a sustain discharge in the cell to the plasma display panel after the charges within the cell are erased using the erase signal.

The voltage of the erase signal is controlled to be within a range between 80V and 280V.

The voltage of the erase signal is controlled to be within a range between 155V and 205V.

The step of controlling the voltage of the erase signal includes controlling the voltage of the erase signal to be higher than a voltage of the sustain signal if the temperature of the plasma display panel rises from room temperature to a high temperature.

The step of controlling the voltage of the erase signal includes controlling the voltage of the erase signal to be lower than a voltage of the sustain signal if the temperature of the plasma display panel falls from room temperature to a low temperature.

The room temperature ranges from 0□ to 50□ and the low temperature ranges from −20□ to 0□.

An apparatus and method for driving a PDP according to a second embodiment of the present invention will now be described in detail with reference to the accompanying drawings.

FIG. 12 shows the configuration of an apparatus for driving a PDP according to a second embodiment of the present invention.

Referring to FIG. 12, the apparatus for driving the PDP according to the second embodiment of the present invention includes a data driving unit 132 for supplying data to address electrodes X1 to Xm of the PDP, a scan driving unit 133 for driving scan electrodes Y1 to Yn, a sustain driving unit 134 for driving a sustain electrode Z being a common electrode, a temperature sensor 137 for sensing a temperature of the PDP, an erase signal voltage control unit 136 for controlling a voltage of an erase signal VRamp-ers being a ramp waveform depending on the temperature of the PDP, a timing controller 131 for controlling the respective driving units 132, 133 and 134 and the erase signal voltage control unit 136, and a driving voltage generator 135 for supplying a driving voltage needed for each of the driving units 132, 133 and 134.

The data driving unit 132 is substantially the same as the data driving unit 122 of the PDP according to the first embodiment of the present invention. Thus, detailed description on the data driving unit 132 will not be given for simplicity.

The scan driving unit 133 supplies a ramp-up waveform Ramp-up and a ramp-down waveform Ramp-down to the scan electrodes Y1 to Yn during a reset period under the control of the timing controller 131. Further, the scan driving unit 133 sequentially supplies a scan pulse Sp to the scan electrodes Y1 to Yn during an address period and supplies a sustain pulse sus to the scan electrodes Y1 to Yn during a sustain period, under the control of the timing controller 131. Also, the scan driving unit 133 applies an erase signal VRamp-ers2 being a ramp waveform whose voltage is controlled by the erase signal voltage control unit 136 to the scan electrodes Y1 to Yn after the last sustain discharge is generated in at least one sub-field.

The sustain driving unit 134 supplies a bias voltage of a sustain voltage (Vs) to the sustain electrode Z during a period where the ramp-down waveform Ramp-down is generated and during the address period and alternately operates with the scan driving unit 133 during the sustain period to apply the sustain pulse sus to the sustain electrode Z, under the control of the timing controller 131. Further, the sustain driving unit 134 applies the erase signal VRamp-ers2 being a ramp waveform whose voltage is controlled by the erase signal voltage control unit 136 to the sustain electrode Z after the last sustain discharge is generated in one or more sub-fields.

The temperature sensor 137 is disposed on a printed circuit board (PCB) that is folded to the rear side of the PDP or an additional device located close to the PDP, and it serves to sense an ambient temperature of the PDP and to supply an electrical signal indicating the sensed temperature to the erase signal voltage control unit 136. The driving units 132, 133 and 134 of the PDP are mounted on the PCB.

The erase signal voltage control unit 136 controls the voltage of the erase signal VRamp-ers2 in response to the temperature sensing signal from the temperature sensor 137 and a control signal CTRRES2 of the timing controller 131. That is, the erase signal voltage control unit 136 supplies the voltage of the erase ramp waveform VRamp-ers2, which is raised to a voltage Vs+ΔV higher than the sustain voltage (Vs), when the temperature of the PDP rises from room temperature to high temperature, and it supplies the voltage of the erase ramp waveform VRamp-ers2, which is lowered to a voltage Vs-ΔV lower than the sustain voltage (Vs), when the temperature of the PDP decreases from room temperature to a low temperature. For this, the erase signal voltage control unit 136 includes a given voltage source for selecting one of the sustain voltage (Vs), the voltage Vs+ΔV higher than the sustain voltage (Vs) and the voltage Vs-ΔV lower than the sustain voltage (Vs) depending on the temperature of the PDP.

In this time, the voltage source has a voltage of 80V to 280V so that it matches a lifespan characteristic of the PDP. It is preferred that the voltage source has a voltage of 155V to 205V. In the above, the room temperature may range from 0□ to 50□, the high temperature may range from 50□ to 100□, the low temperature may range from −20□ to 0□.

Meanwhile, the erase signal voltage control unit 136 can be built in the scan driving unit 133 or the sustain driving unit 134.

The timing controller 131 receives a vertical/horizontal synchronization signal and a clock signal, and generates timing control signals CTRX, CTRY, CTRZ and CTRERS2 for controlling an operating timing and synchronization of each of the driving units 132, 133 and 134 and the erase signal voltage control unit 136. The timing controller 131 also applies the timing control signals CTRX, CTRY, CTRZ and CRRERS2 to corresponding driving units 132, 133 and 134 and the erase signal voltage control unit 136, thus controlling the driving units 132, 133 and 134 and the erase signal voltage control unit 136. The data control signal CTRX includes a sampling clock for sampling data, a latch control signal, and a switch control signal for controlling an on/off time of an energy recovery circuit and a driving switch element. The scan control signal CTRY includes a switch control signal for controlling an on/off time of an energy recovery circuit and a driving switch element within the scan driving unit 133. The sustain control signal CTRZ includes a switch control signal for controlling an on/off time of an energy recovery circuit and a driving switch element within the sustain driving unit 134. Further, the control signal CTRRES2 includes a control signal of switch elements included in the erase signal voltage control unit 136.

The driving voltage generator 135 generates the set-up voltage Vsetup, the common scan voltage Vscan-com, the scan voltage (−Vy), the sustain voltage (Vs), the data voltage (Vd), the voltage Vs+ΔV higher than the sustain voltage (Vs), the voltage Vs-Δ lower than the sustain voltage (Vs) and the like. These driving voltages may vary depending on the composition of a discharge gas or the construction of a discharge cell.

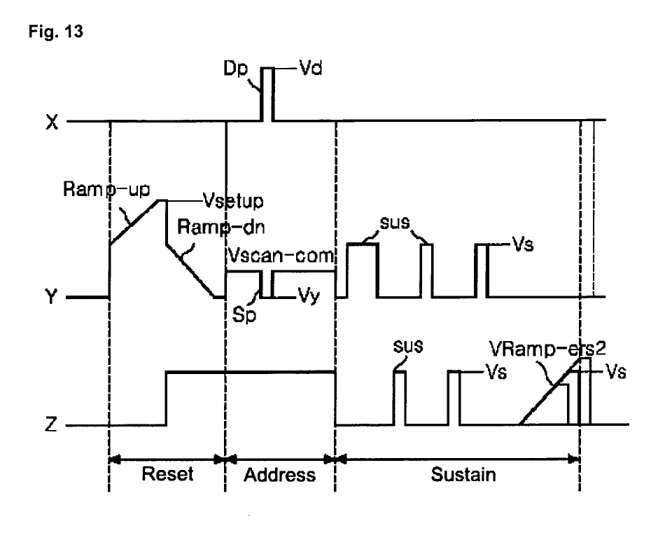

FIG. 13 shows a driving waveform for explaining a method of driving a PDP according to a second embodiment of the present invention.

Referring to FIG. 13, in the method of driving the PDP according to the second embodiment of the present invention, one frame period is time-divided into a plurality of sub-fields each of which has a reset period, an address period and a sustain period. A voltage of an erase signal applied after a sustain discharge in one or more sub-fields varies depending on an ambient temperature. That is, a temperature of the PDP is sensed, the voltage of the erase signal for erasing charges within cells of the PDP is controlled depending on the sensed temperature, and an initialization signal for initializing the cell after the charges within the cell are erased using the erase signal, an address signal for selecting the cell and a sustain signal for generating the sustain discharge in the cell are supplied to the PDP. This will be below described in detail.

Firstly, at the initial stage of the reset period, a ramp-up waveform Ramp-up is supplied to all the scan electrodes Y simultaneously. At the same time, a voltage of 0[V] is applied to the sustain electrode Z and the address electrodes X. The ramp-up waveform Ramp-up causes a writing dark discharge in which light is rarely generated to occur between the scan electrodes Y and the address electrodes X and between the scan electrodes Y and the sustain electrode Z within the cells of the whole screen. Wall charges of the positive (+) polarity are accumulated on the address electrodes X and the sustain electrode Z and wall charges of the negative (−) polarity are accumulated on the scan electrodes Y, by means of the writing dark discharge. This writing dark discharge varies depending on the voltage of the erase signal Vramp-ers2 being the ramp waveform immediately before the reset period.

After the ramp-up waveform Ramp-up, a ramp-down waveform Ramp-dn in which a voltage starts to fall from a voltage of the positive polarity lower than the peak voltage of the ramp-up waveform Ramp-up to a ground voltage GND or a given voltage level of the negative polarity is supplied to the scan electrodes Y simultaneously. At the same time, the sustain voltage (Vs) is applied to the sustain electrode Z and a voltage of 0[V] is supplied to the address electrodes X. When the ramp-down waveform Ramp-dn is applied, an erasing dark discharge is generated between the scan electrodes Y and the sustain electrode Z. Excessive wall charges that are unnecessary for the address discharge among the wall charges generated upon the writing dark discharge are erased by the erasing dark discharge. Variation in distribution of the wall charges in the reset period will now be examined. There is almost no variation in the wall charges on the address electrodes X, but some of the wall charges of the negative polarity, which are formed on the scan electrodes Y by the writing dark discharge, are erased by the erasing dark discharge. On the contrary, in the case of the wall charges on the sustain electrode Z, although the wall charges of the positive polarity was accumulated in the writing dark discharge, the wall charges of the negative polarity are accumulated as much as the amount that the wall charges on the scan electrodes Y are reduced as the wall charges of the negative polarity that are accumulated on the scan electrodes Y at the time of the erasing dark discharge are moved to the sustain electrode Z. Therefore, the polarity of the wall charges on the sustain electrode Z is changed from the positive polarity to the negative polarity immediately after the erasing dark discharge.

In the address period, a scan pulse Sp is sequentially supplied to the scan electrodes Y, and at the same time a data pulse Dp synchronized with the scan pulse Sp is provided to the address electrodes X. As a voltage difference between the scan pulse Sp and the data pulse Dp and a wall voltage generated in the reset period are added, an address discharge is generated within cells to which the data pulse Dp is supplied. Wall charges of the degree that can causes a discharge to occur when the sustain voltage (Vs) is applied are formed within a cell selected by the address discharge. During the address period, the sustain voltage (Vs) is applied to the sustain electrode Z. This address discharge varies depending on the amount of initial wall charges generated upon the writing dark discharge that varies when the voltage of the erase signal is changed.

In the sustain period, a sustain pulse sus is alternately applied to the scan electrodes Y and the sustain electrode Z. As the wall voltage within the cells and the sustain pulse sus are added, a sustain discharge, i.e., a display discharge is generated between the scan electrodes Y and the sustain electrode Z in the cell selected by the address discharge whenever the sustain pulse sus is supplied.

After the sustain discharge is completed, the erase signal VRamp-ers2 whose voltage varies depending on an ambient temperature of the PDP is supplied to the sustain electrode Z, thus erasing the wall charges remaining in the cells of the whole screen. That is, the erase signal VRamp-ers2 serves to compensate for the amount of the wall charges on the scan electrode and the address electrodes depending on a temperature by controlling the writing dark discharge of the reset period. The voltage of the erase signal is controlled to have a voltage higher than a sustain voltage when the temperature of the PDP rises from room temperature to a high temperature and a voltage lower than the sustain voltage when the temperature of the PDP decreases from room temperature to a low temperature. In this time, the voltage of the erase signal VRamp-ers2 is controlled to vary at a sustain voltage (Vs)±100V, e.g., between 80V and 280V when the sustain voltage (Vs) is 180V considering the lifespan characteristic of the panel. Preferably, the voltage of the erase signal VRamp-ers2 is controlled to vary at a sustain voltage (Vs)±25V, e.g., between 155V and 205V when the sustain voltage (Vs) is 180V considering the lifespan characteristic of the panel. In the concrete, if an ambient temperature of the PDP rises from room temperature to a high temperature, the voltage of the erase signal VRamp-ers2 is raised to a voltage higher than the sustain voltage (Vs), e.g., a voltage between 180V and 280V, thus preventing a high temperature erroneous discharge. On the contrary, if an ambient temperature of the PDP falls from room temperature to a low temperature, the voltage of the erase signal VRamp-ers2 is raised to a voltage lower than the sustain voltage (Vs), e.g., a voltage between 80V and 180V, thus a low temperature erroneous discharge.

In the same manner as the first embodiment, the room temperature can range from 0□ to 50□, the high temperature can range from 50□ to 100□, and the low temperature can range from −20□ to 0□.

As described above, in the method of driving the PDP according to the second embodiment of the present invention, the voltage of the erase signal VRamp-ers varies depending on a temperature. Thus, an address discharge can be stabilized in any environment by preventing a high temperature erroneous discharge or a low temperature erroneous discharge although the PDP is used at high temperature or low temperature.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for driving a plasma display panel, comprising:
a temperature sensor that senses a temperature of the plasma display panel;
an erase signal tilt control unit that controls a tilt of an erase signal for erasing charges within a cell of the plasma display panel depending on the sensed temperature; and
a driving unit that supplies an initialization signal for initializing the cell, an address signal for selecting the cell and a sustain signal for generating a sustain discharge in the cell to the plasma display panel after the charges within the cell are erased using the erase signal.

2. The apparatus as claimed in claim 1, wherein the erase signal tilt control unit controls the tilt of the erase signal to vary within a range between 0.1V/μs and 1800V/μs.

3. The apparatus as claimed in claim 2, wherein the erase signal tilt control unit controls the tilt of the erase signal to vary within a range between 2V/μs and 20V/μs.

4. The apparatus as claimed in claim 1, wherein the erase signal tilt control unit controls the tilt of the erase signal to be higher than a reference tilt at room temperature if the temperature of the plasma display panel rises from room temperature to a high temperature.

5. The apparatus as claimed in claim 1, wherein the erase signal tilt control unit controls the tilt of the erase signal to be lower than a reference tilt at room temperature if the temperature of the plasma display panel falls from room temperature to a low temperature.

6. A method of driving a plasma display panel, comprising the steps of:
sensing a temperature of the plasma display panel;
controlling a tilt of an erase signal for erasing charges within a cell of the plasma display panel depending on the sensed temperature;
erasing the charges within the cell using the erase signal; and
supplying an initialization signal for initializing the cell, an address signal for selecting the cell and a sustain signal for generating a sustain discharge in the cell to the plasma display panel.

7. The method as claimed in claim 6, wherein the tilt of the erase signal varies within a range between 0.1V/μs and 1800V/μs.

8. The method as claimed in claim 7, wherein the tilt of the erase signal varies within a range between 2V/μs and 20V/μs.

9. The method as claimed in claim 6, wherein the step of controlling the tilt of the erase signal includes controlling the tilt of the erase signal to be higher than a reference tilt at room temperature if the temperature of the plasma display panel rises from room temperature to a high temperature.

10. The method as claimed in claim 6, wherein the step of controlling the tilt of the erase signal includes controlling the tilt of the erase signal to be lower than a reference tilt at room temperature if the temperature of the plasma display panel falls from room temperature to a slow temperature.

11. An apparatus for driving a plasma display panel, comprising:
a temperature sensor that senses a temperature of the plasma display panel;
an erase signal voltage control unit that controls a voltage of an erase signal for erasing charges within a cell of the plasma display panel depending on the sensed temperature; and
a driving unit that supplies an initialization signal for initializing the cell, an address signal for selecting the cell and a sustain signal for generating a sustain discharge in the cell to the plasma display panel after the charges within the cell are erased using the erase signal.

12. The apparatus as claimed in claim 11, wherein the erase signal voltage control unit raises the voltage of the erase signal up to a voltage within a range between 80V and 280V.

13. The apparatus as claimed in claim 12, wherein the erase signal voltage control unit raises the voltage of the erase signal up to a voltage within a range between 155V and 205V.

14. The apparatus as claimed in claim 11, wherein the erase signal voltage control unit controls the voltage of the erase signal to be higher than a voltage of the sustain signal if the temperature of the plasma display panel rises from room temperature to a high temperature.

15. The apparatus as claimed in claim 11, wherein the erase signal voltage control unit controls the voltage of the erase signal to be lower than a voltage of the sustain signal if the temperature of the plasma display panel falls from room temperature to a low temperature.

16. A method of driving a plasma display panel, comprising the steps of:
sensing a temperature of the plasma display panel;
controlling a voltage of an erase signal for erasing charges within a cell of the plasma display panel depending on the sensed temperature;
erasing the charges within the cell using the erase signal; and
supplying an initialization signal for initializing the cell, an address signal for selecting the cell and a sustain signal for generating a sustain discharge in the cell to the plasma display panel.

17. The method as claimed in claim 16, wherein the voltage of the erase signal is controlled to be within a range between 80V and 280V.

18. The method as claimed in claim 17, wherein the voltage of the erase signal is controlled to be within a range between 155V and 205V.

19. The method as claimed in claim 16, wherein the step of controlling the voltage of the erase signal includes controlling the voltage of the erase signal to be higher than a voltage of the sustain signal if the temperature of the plasma display panel rises from room temperature to a high temperature.

20. The method as claimed in claim 16, wherein the step of controlling the voltage of the erase signal includes controlling the voltage of the erase signal to be lower than a voltage of the sustain signal if the temperature of the plasma display panel falls from room temperature to a low temperature.

21. The method as claimed in claim 4 of 14, wherein the room temperature ranges from 0° C. and 50° C. and the high temperature ranges from 50° C. to 100° C.

22. The method as claimed in claim 5 er 15, wherein the room temperature ranges from 0° C. to 50° C. and the low temperature ranges from −20° C. to 0° C.

23. The method as claimed in claim 9, wherein the room temperature ranges from 0° C. and 50° C. and the high temperature ranges from 50° C. to 100° C.

24. The method as claimed in claim 10, wherein the room temperature ranges from 0° C. to 50° C. and the low temperature ranges from −20° C. to 0° C.

25. The method as claimed in claim 14, wherein the room temperature ranges from 0° C. and 50° C. and the high temperature ranges from 50° C. to 100° C.

26. The method as claimed in claim 15, wherein the room temperature ranges from 0° C. to 50° C. and the low temperature ranges from −20° C. to 0° C.

27. The method as claimed in claim 19, wherein the room temperature ranges from 0° C. and 50° C. and the high temperature ranges from 50° C. to 100° C.

28. The method as claimed in claim 20, wherein the room temperature ranges from 0° C. and 50° C. and the low temperature ranges from −20° C. to 0° C.
